(19) United States
(12) Patent Application Publication
(10) Pub. No.: US 2024/0296644 A1
(43) Pub. Date: Sep. 5, 2024

(54) GENERATING VIRTUAL USER DEVICES IN A VIRTUAL ENVIRONMENT THAT MIRROR REAL-WORLD USER DEVICES IN A REAL-WORLD ENVIRONMENT

(71) Applicant: SPHERE ENTERTAINMENT GROUP, LLC, New York, NY (US)

(72) Inventor: Benjamin POYNTER, Los Angeles, CA (US)

(73) Assignee: SPHERE ENTERTAINMENT GROUP, LLC, New York, NY (US)

(21) Appl. No.: 18/660,725

(22) Filed: May 10, 2024

Related U.S. Application Data
(63) Continuation-in-part of application No. 18/482,067, filed on Oct. 6, 2023.
Application No. 18/482,067 is a continuation of application No. 17/314,252, filed on May 7, 2021, now Pat. No. 11,823,344.

(51) Int. Cl. G06T 19/20; G06T 7/246; G06T 7/73

(52) U.S. Cl. CPC G06T 19/20; G06T 7/246; G06T 7/73; G06T 2207/10016; G06T 2219/2004

(57) ABSTRACT

Systems, methods, and apparatuses can access one or more real-world images, also referred to as video, of one or more real-world user devices within a real-world environment. These systems, methods, and apparatuses can capture one or more real-world images, also referred to as video, of one or more tracking markers being displayed by the one or more real-world user devices. These systems, methods, and apparatuses can estimate position, orientation, for example, roll, pitch, and/or yaw, and/or motion of the one or more real-world devices in the real-world environment based upon the one or more tracking markers. These systems, methods, and apparatuses can render one or more virtual user devices to have substantially similar positions, substantially similar orientations, for example, rolls, pitches, and/or yaws, and/or substantially similar motions as the one or more real-world devices in the real-world environment. These systems, methods, and apparatuses can display the one or more virtual user devices in a virtual environment.

### CROSS-REFERENCE TO RELATED APPLICATIONS

The present application is a continuation-in-part of U.S. patent application Ser. No. 18/482,067, filed Oct. 6, 2023, which is a continuation of U.S. patent application Ser. No. 17/314,252, filed May 7, 2021, now U.S. Pat. No. 11,823,344, each of which is incorporated herein by reference in its entirety.

### BACKGROUND

Virtual reality creates immersive virtual environments that mimic real-world experiences, blurring the line between physical and virtual realties. By simulating senses through headsets and controllers, virtual reality can transport users to fantastical realms or simulate real-life scenarios for training, entertainment, or therapeutic purposes. While virtual reality offers unparalleled escapism and novel experiences, it has potential to revolutionize fields like education, healthcare, and communication by offering new ways to learn, treat patients, and connect with others in a virtual environment regardless of physical distance.

### BRIEF DESCRIPTION OF THE DRAWINGS

The present disclosure is described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1 illustrates a simplified block diagram of an exemplary real-world environment according to some exemplary embodiments of the present disclosure;

FIG. 2 illustrates exemplary reference tracking markers that can be used to calibrate an exemplary virtual reality display device within the exemplary real-world environment according to some exemplary embodiments of the present disclosure;

FIG. 3A and FIG. 3B illustrate an exemplary real-world user device within the exemplary real-world environment and exemplary tracking markers that can be displayed by the exemplary real-world user device according to some exemplary embodiments of the present disclosure;

FIG. 4 illustrates an exemplary virtual reality display device within the exemplary real-world environment according to some exemplary embodiments of the present disclosure;

FIG. 5 illustrates an exemplary operational control flow for the exemplary real-world environment in accordance with some exemplary embodiments of the present disclosure; and

FIG. 6 illustrates a simplified block diagram of an exemplary computer system that can be implemented within the exemplary real-world environment according to some exemplary embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1-15% of the value (e.g., ±1%, ±2%, ±5%, ±10%, or ±15% of the value).

### Overview

Systems, methods, and apparatuses can access one or more real-world images, also referred to as video, of one or more real-world user devices within a real-world environment. These systems, methods, and apparatuses can capture one or more real-world images, also referred to as video, of one or more tracking markers being displayed by the one or more real-world user devices. These systems, methods, and apparatuses can estimate position, orientation, for example, roll, pitch, and/or yaw, and/or motion of the one or more real-world devices in the real-world environment based upon the one or more tracking markers. These systems, methods, and apparatuses can render one or more virtual user devices to have substantially similar positions, substantially similar orientations, for example, rolls, pitches, and/or yaws, and/or substantially similar motions as the one or more real-world devices in the real-world environment. These systems, methods, and apparatuses can display the one or more virtual user devices in a virtual environment.

### Exemplary Real-World Environment

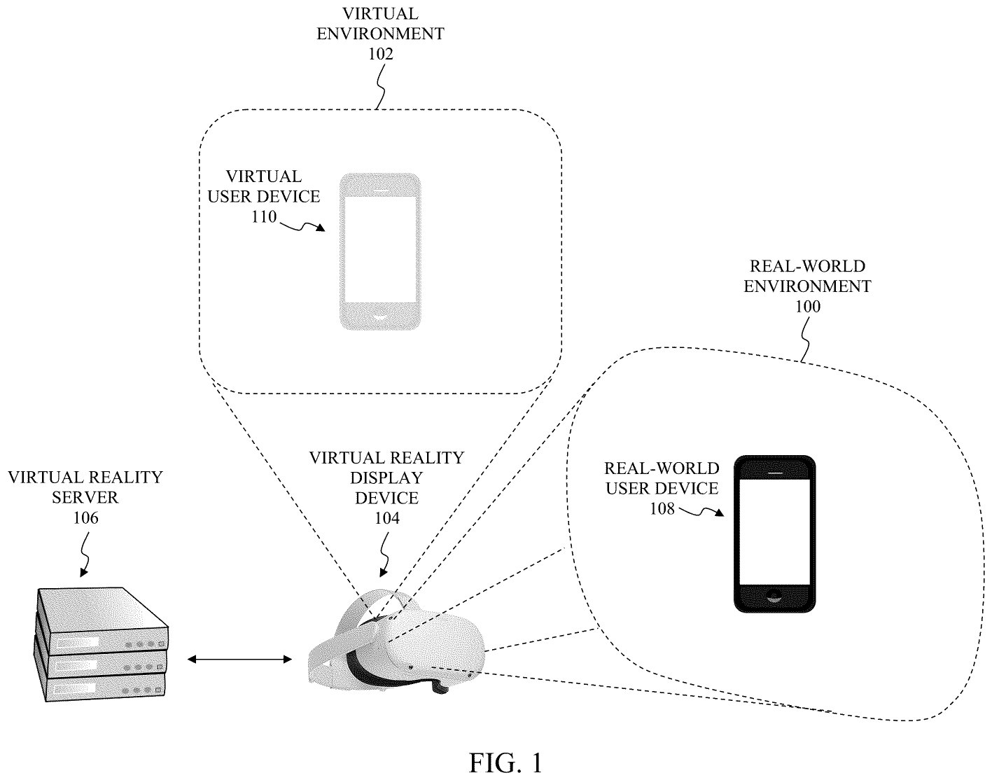

FIG. 1 illustrates a simplified block diagram of an exemplary real-world environment according to some exemplary embodiments of the present disclosure. In the exemplary embodiment illustrated in FIG. 1, one or more real-world images, also referred to as video, of one or more real-world user devices can be captured within a real-world environment 100. Although the discussion herein can describe the real-world environment 100 and/or a virtual environment 102 as performing certain actions, operations, routines, procedures, or the like, it should be appreciated that such descriptions are merely for convenience and that such actions, operations, routines, procedures, or the like result from operation, functioning, performance, activity, execution, use, utilization, process, or the like of one or more electrical, mechanical, and/or electro-mechanical devices within the real-world environment 100 that will be apparent to those skilled in the relevant art(s) without departing from the spirit and scope of the present disclosure. As described herein, the one or more real-world images of one or more real-world user devices can be transformed into one or more virtual images of one or more virtual user devices. And as to be described herein, the one or more virtual images of one or more virtual user devices can be displayed in the virtual environment 102 to provide immersive interactions between the one or more real-world user devices in the real-world environment 100 and one or more virtual user devices in the virtual environment 102. As illustrated in FIG. 1, the real-world environment 100 can include a virtual reality display device 104 and a virtual reality server 106.

In the exemplary embodiment illustrated in FIG. 1, the virtual reality display device 104 can provide immersive interaction between a real-world user device 108 within the real-world environment 100 and a virtual user device 110 within a virtual environment 102. In some embodiments, the virtual user device 110 can mirror behavior and/or functionality of the real-world user device 108 in the virtual environment. For example, the virtual user device 110 can emulate the real-world movement of the real-world user device 108 within the virtual environment 102. In some embodiments, the real-world user device 108 can include one or more electrical, mechanical, and/or electro-mechanical devices, such as one or more cellular phones, smartphones, feature phones, tablet computers, wearable computer devices, personal digital assistants (PDAs), pagers, wireless handsets, desktop computers, laptop computers, digital cameras, e-readers, gaming consoles, smartwatches, fitness trackers, smart televisions, home assistants, networked or “smart” appliances, portable media players, Bluetooth speakers, headphones, earbuds, home automation devices, drones, wearable technology, and the like. In some embodiments, the virtual reality display device 104 can include a virtual reality headset, virtual reality glasses, a holographic display, and/or an immersive simulator, among others.

As illustrated in FIG. 1, the virtual reality display device 104 can capture, or acquire, one or more real-world images, also referred to as video, of the real-world user device 108 in the real-world environment 100. In some embodiments, the virtual reality display device 104 can capture the one or more real-world images of the real-world user device 108 within a real-world field of view of the virtual reality display device 104 in the real-world environment 100. In these embodiments, the real-world field of view of the virtual reality display device 104 can represent the portion of the real-world environment 100 that is capable of being viewed and/or captured by the virtual reality display device 104. In some embodiments, the virtual reality display device 104 can capture one or more real-world images, also referred to as video, of one or more tracking markers being displayed by the real-world user device 108. In these embodiments, the one or more tracking markers can be characterized as being visual cues, or patterns, that are displayed by the real-world user device 108 to aid in determining the position, the orientation, and/or the motion of the real-world user device 108 in the real-world environment 100. The one or more tracking markers can include simple fiducial markers such as simple patterns, for example, fiducial markers having simple shapes such as crosses, circles, squares, or the like. However, more complex fiducial markers, for example, ArUco markers, AprilTags, chessboard grids, and even Quick Response (QR) codes, are possible as will be recognized by those skilled in the relevant art(s) without departing from the spirit and scope of the present disclosure. In some embodiments, the virtual reality display device 104 can include, or be integrated with, one or more cameras, referred to as internal cameras, to capture the one or more real-world images of the real-world user device 108 in the real-world environment 100. In some embodiments, these internal cameras can be used to track the real-world user device 108 in the real-world environment 100 in a process referred to as inside-out tracking. Alternatively, or in addition to, the virtual reality display device 104 can be communicatively coupled to one or more cameras, referred to as external cameras, to capture the one or more real-world images of the real-world user device 108 in the real-world environment 100. In some embodiments, these external cameras can be used to track the real-world user device 108 in the real-world environment 100 in a process referred to as outside-in tracking.

In the exemplary embodiment illustrated in FIG. 1, the virtual reality server 106 can generate the virtual user device 110 based upon the one or more real-world images of the real-world user device 108 that have been captured by the virtual reality display device 104 as described herein. In some embodiments, the virtual reality server 106 can access the one or more real-world images of the real-world user device 108 that have been captured by the virtual reality display device 104. In these embodiments, the virtual reality server 106 can receive these real-world images from the virtual reality display device 104. In some embodiments, the virtual reality server 106 can process the one or more real-world images of the real-world user device 108 to generate the virtual user device 110 for display in the virtual environment 102. In these embodiments, the virtual reality server 106 can execute various computer vision and/or machine learning implemented firmware, software, routines, instructions, or the like, such as the Open-Source Computer Vision Library (OpenCV), the Python Imaging Library (PIL), MATLAB, and/or Pillow among others to provide some examples, to process the one or more real-world images of the real-world user device 108. As part of this processing, the virtual reality server 106 can detect and/or extract the one or more tracking markers from the one or more real-world images of the real-world user device 108. In some embodiments, the processing can include image and video manipulation, such as resizing, cropping, rotating, and/or filtering to provide some examples, object detection, and/or object tracking, among others of the one or more real-world images of the real-world user device 108 to detect and/or extract the one or more tracking markers.

As part of this processing, the virtual reality server 106 can process the one or more tracking markers to estimate the position, the orientation, for example, roll, pitch, and/or yaw, and/or the motion of the real-world user device 108 in the real-world environment 100. Generally, the position, the orientation, for example, roll, pitch, and/or yaw, and/or the motion of the real-world user device 108 in the real-world environment 100 is referred to as the pose of the real-world user device 108. In some embodiments, the virtual reality server 106 can estimate the pose of the real-world user device 108 relative to the virtual reality display device 104 from the one or more tracking markers. In these embodiments, the virtual reality server 106 can effectively solve for one or more transformation matrices that map three-dimensional coordinates of the one or more tracking markers onto three-dimensional coordinates of the virtual reality display device 104. In these embodiments, the virtual reality server 106 can map these three-dimensional coordinates in accordance with Perspective-in-Point (PnP) methods, feature-based methods, direct methods that estimate the pose directly from the pixel intensity values of the one or more tracking markers, deep-learning based methods, and/or bundle adjustment, among others.

As part of this processing, the virtual reality server 106 can generate the virtual user device 110 for display in the virtual environment 102 that is associated with the real-world user device 108 in the real-world environment 100. In some embodiments, the virtual reality server 106 can generate the virtual user device 110 for display in the virtual environment 102 having a substantially similar position, a substantially similar orientation, for example, roll, pitch, and/or yaw, and/or a substantially similar motion as the real-world user device 108 in the real-world environment 100. In some embodiments, the virtual reality server 106 can decode the one or more tracking markers extracted from the one or more real-world images of the real-world user device 108 as described herein to identify one or more virtual images, or video, that are associated with the virtual user device 110. In these embodiments, the virtual reality server 106 can decode the one or more tracking markers using image processing techniques, such as thresholding, contour direction, and/or pattern recognition, among others. In some embodiments, the virtual reality server 106 can decode the one or more tracking markers to identify one or more virtual images, or video, to be displayed in the virtual environment 102 as the virtual user device 110. In these embodiments, the virtual reality server 106 can decode the one or more tracking markers to recover one or more identifiers and/or metadata, among others, which have been encoded within the one or more tracking markers. In these embodiments, the virtual reality server 106 can access the one or more virtual images, or video, to be displayed in the virtual environment 102 as the virtual user device 110 that are associated with the one or more identifiers. In these embodiments, the one or more virtual images, or video, can represent the real-world user device 108. Alternatively, or in addition to, the one or more virtual images, or video, can supplement the real-world user device 108, for example, include a hand of a user operating the real-world user device 108. In some embodiments, the virtual reality server 106 can render the one or more virtual images, or video, to have the substantially similar position, the substantially similar orientation, and/or the substantially similar motion as the real-world user device 108 in the real-world environment 100 to generate the virtual user device 110.

The virtual reality display device 104 can access the virtual user device 110 that has been generated by the virtual reality server 106 for display in the virtual environment 102. In these embodiments, the virtual reality display device 104 can receive the virtual user device 110 from the virtual reality server 106. In some embodiments, the virtual reality display device 104 can render the virtual user device 110 onto one or more virtual surfaces in the virtual environment 102. In these embodiments, the virtual reality display device 104 can execute one or more graphical image rendering algorithms to render the virtual user device 110 for display in the virtual environment 102. In some embodiments, the one or more graphical image rendering algorithms can include one or more scanline rendering and rasterization algorithms, one or more ray casting algorithms, one or more ray tracing algorithms, one or more neural rendering algorithms, and/or any other suitable graphical image rendering algorithms that will be apparent to those skilled in the relevant art(s) without departing from the spirit and scope of the present disclosure. As to be described in further detail below, the one or more graphical image rendering algorithms, when executed by the virtual reality display device 104, can manipulate one or more parameters, characteristics, and/or attributes, for example, orientations, scales, lighting, and/or angles, of the virtual user device 110 to render the virtual user device 110 for display in the virtual environment 102. In some embodiments, the one or more graphical image rendering algorithms, when executed by the virtual reality display device 104, can introduce one or more graphical image effects, such as shading, texture-mapping, bump-mapping, fogging, shadowing, reflecting, transparency, refracting, diffracting, illuminating, depth of field, motion blur, and/or non-photorealistic rendering to provide some examples, into the virtual user device 110. After rendering the virtual user device 110, the virtual reality display device 104 can display the virtual user device 110 in the virtual environment 102. In some embodiments, the virtual reality display device 104 can generate one or more virtual surfaces within the virtual environment 102 and thereafter project the virtual user device 110 onto these virtual surfaces to display the virtual user device 110 in the virtual environment 102.

Exemplary Calibration of an Exemplary Virtual Reality Display Device within the Exemplary Real-World Environment

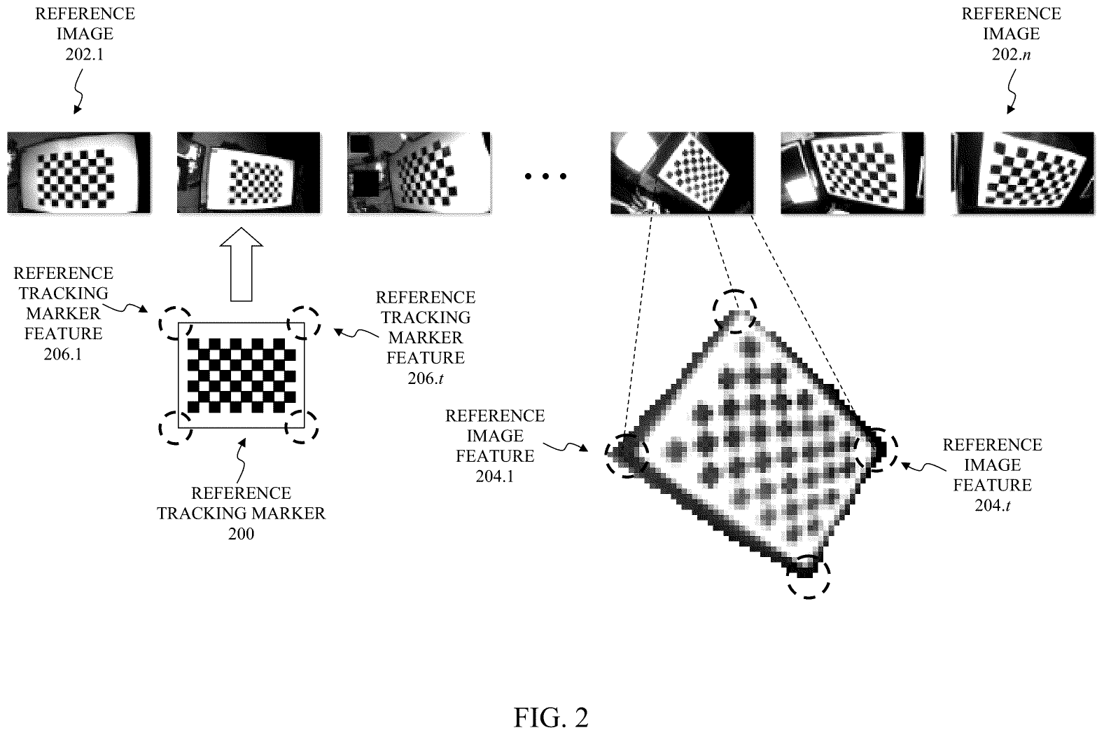

FIG. 2 illustrates exemplary reference tracking markers that can be used to calibrate an exemplary virtual reality display device within the exemplary real-world environment according to some exemplary embodiments of the present disclosure. It can be advantageous for a virtual reality display device, such as the virtual reality display device 104 to provide an example, to execute a calibration process for a virtual reality server, such as the virtual reality server 106 to provide an example, to obtain more accurate geometric information from one or more real-world images, such as the one or more real-world images of the real-world user device 108 captured by the virtual reality display device as described herein.

As illustrated in FIG. 2, the virtual reality server can access one or more reference tracking markers 200, for example, one or more checkerboard patterns, circles, and/or asymmetric circles, among others, having various geometric properties to be used for the calibration process. In some embodiments, the virtual reality display device can capture multiple reference images 202.1 through 202.n of the one or more reference tracking markers at different poses, for example, different positions, different orientations, for example, roll, pitch, and/or yaw, and/or different motions in relation to the virtual reality display device. In these embodiments, the virtual reality server can detect one or more reference image features 204.1 through 204.t, such as one or more corners, edges, and/or points, among others to provide some examples, of the one or more reference tracking markers 200 from the multiple reference images 202.1 through 202.n. In some embodiments, the virtual reality server can use one or more image processing techniques, such as thresholding, contour direction, and/or pattern recognition, among others, to detect the one or more reference image features 204.1 through 204.t.

In some embodiments, the virtual reality server can apply one or more calibration algorithms to the one or more reference image features 204.1 through 204.t to estimate intrinsic camera parameters, for example, focal length, or principal point, among others, and/or one or more extrinsic camera properties, for example, camera pose, among others, within the one or more camera models. Generally, the one or more calibration algorithms analyze relationships between three-dimensional coordinates of known reference image features 206.1 through 206.t, such as one or more corners, edges, and/or points, among others to provide some examples, in a real-world environment, such as the real-world environment 100 to provide an example, and corresponding two-dimensional coordinates of the reference image features 204.1 through 204.t from among the multiple reference images 202.1 through 202.n. In some embodiments, the one or more calibration algorithms can include, for example, Tsai's algorithm, Zhang's algorithm, direct linear transformation (DLT), bundle adjustment, Levenberg-Marquardt optimization, and/or gradient descent, among others.

In some embodiments, the virtual reality server can identify one or more camera models, for example, pinhole camera model, fisheye camera model, and/or radial distortion models, among others, to describe the relationships between the three-dimensional coordinates of the known reference image features 206.1 through 206.t and the corresponding two-dimensional coordinates of the reference image features 204.1 through 204.t. In these embodiments, the virtual reality server can use the one or more camera models to predict three-dimensional coordinates of the reference image features 204.1 through 204.t in the real-world environment. In some embodiments, the virtual reality server can optimize the one or more camera models. In these embodiments, the virtual reality server can estimate the one or more intrinsic camera parameters and/or the one or more extrinsic camera properties corresponding to the one or more camera models. In these embodiments, the virtual reality server can selectively adjust the one or more intrinsic camera parameters and/or the one or more extrinsic camera properties to minimize the error, often in terms of reprojection error, between the three-dimensional coordinates of the one or more reference tracking markers 200 in the real-world environment 100 and the three-dimensional coordinates of the reference image features 204.1 through 204.t in the real-world environment that have been predicted.

Exemplary Real-World User Device within the Exemplary Real-World Environment

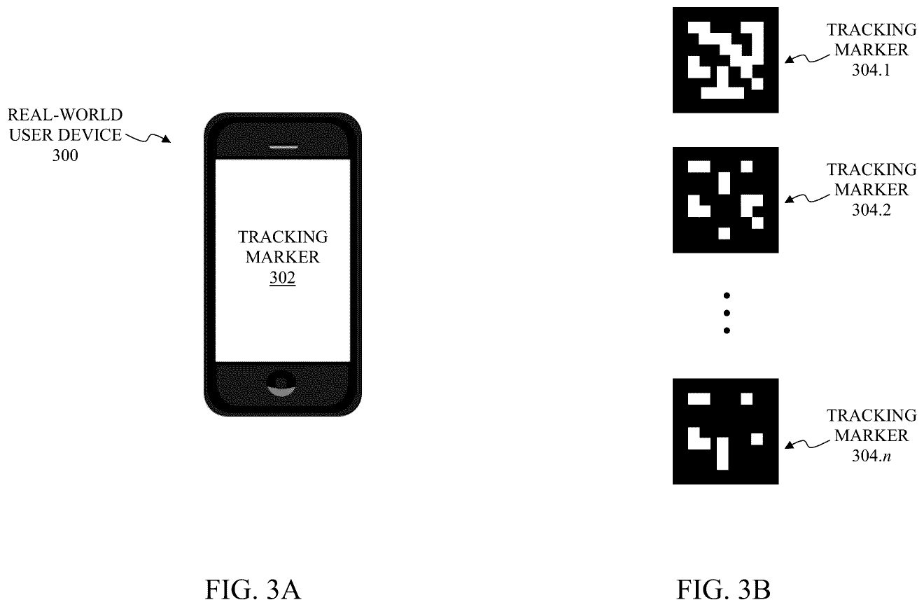

FIG. 3A and FIG. 3B illustrate an exemplary real-world user device within the exemplary real-world environment and exemplary tracking markers that can be displayed by the exemplary real-world user device according to some exemplary embodiments of the present disclosure. In the exemplary embodiment illustrated in FIG. 3A, a real-world user device 300 can display a tracking marker 302 to aid a virtual reality display device 104 and/or a virtual reality server, such as the virtual reality display device 104 and/or the virtual reality server 106, respectively to provide an example, in determining the position, the orientation, and/or the motion of the real-world user device 300. In some embodiments, the real-world user device 300 can represent an exemplary embodiment of the real-world user device 108 as described herein. Although the real-world user device 300 is illustrated as being a smartphone in FIG. 3A, this is for exemplary purposes only and not limiting. Generally, the real-world user device 300 can be any suitable electrical, mechanical, and/or electro-mechanical device that is capable of displaying, or projecting, the tracking marker 302. In some embodiments, this suitable electrical, mechanical, and/or electro-mechanical device can include a cellular phone, a feature phone, a tablet computer, a wearable computer device, a personal digital assistant (PDA), a pager, a wireless handset, a desktop computer, a laptop computer, a digital camera, a e-reader, a gaming console, a smartwatch, a fitness tracker, a smart television, a home assistant, a networked or “smart” appliance, a portable media player, a Bluetooth speaker, a headphone, an earbud, a home automation device, a drone, wearable technology, and the like. Generally, the tracking marker 302 can include one or more known visual cues, or known patterns, with a known size that are displayed by the real-world user device 300, for example, to aid in determining the position, the orientation, and/or the motion of the real-world user device 300 as described herein. These known visual cues are specifically designed to allow rapid, low-latency detection of position estimation in six dimensions, for example, three-dimensional position and/or three-dimensional orientation as described herein. FIG. 3B graphically illustrates tracking markers 304.1 through 304.n that can be displayed by the real-world user device 300 as the tracking marker 302. However, the tracking markers 304.1 through 304.n as illustrated in FIG. 3B are for exemplary purposes only. Those skilled in the relevant art(s) will recognize that the tracking markers 304.1 through 304.n can alternatively, or additionally, include other types of tracking markers, such as AprilTags, chessboard grids, and even Quick Response (QR) codes, without departing from the spirit and scope of the present disclosure. As illustrated in FIG. 3B, the tracking markers 304.1 through 304.n can include unique inner binary matrices having different patterns of black and white squares surrounded by a black border. In some embodiments, these inner binary matrices can be decoded to recover one or more identifiers and/or metadata as described herein.

Exemplary Virtual Reality Display Device within the Exemplary Real-World Environment

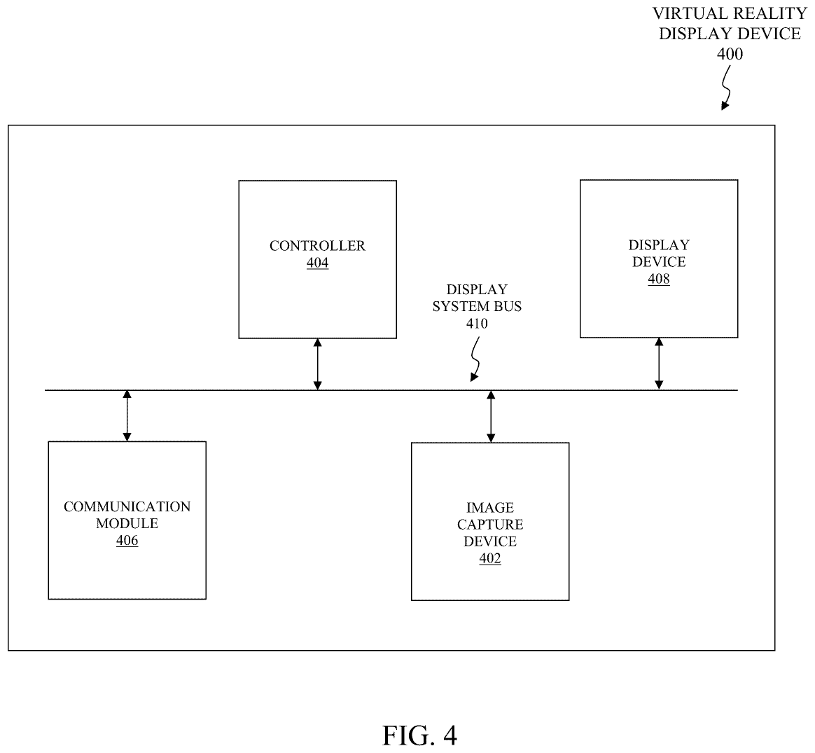

FIG. 4 illustrates an exemplary virtual reality display device within the exemplary real-world environment according to some exemplary embodiments of the present disclosure. A virtual reality display device 400 can capture, or acquire, one or more real-world images, also referred to as video, of a real-world user device, such as the real-world user device 108 and/or the real-world user device 300 as described herein. The virtual reality display device 400 can display a virtual user device in a virtual environment, such as the virtual user device 110 in the virtual environment 102 to provide an example, which can mirror the behavior and/or the functionality of the real-world user device in the virtual environment. As illustrated in FIG. 4, the virtual reality display device 400 can include an image capture device 402, a controller 404, a communication module 406, and a display device 408 that are communicatively coupled to one another via a display system bus 410. Although the virtual reality display device 400 is illustrated as including the image capture device 402, the controller 404, the communication module 406, and the display device 408, those skilled in the relevant art(s) will recognize that the virtual reality display device 400 can alternatively, or additionally, include other components without departing from the spirit and scope of the present disclosure. These other components can include lenses to focus images; sensors, such as gyroscopes and/or accelerometers, among others; built-in headphones or speakers; and/or hand-held devices, or controllers, for interacting with the virtual environment, among others.

The image capture device 402 can capture, or acquire, one or more real-world images, also referred to as video, of the real-world user device in a real-world environment, such as the real-world environment 100 as described herein. In some embodiments, the image capture device 402 can capture the one or more real-world images of the real-world user device within a real-world field of view of the image capture device 402 in the real-world environment. In these embodiments, the real-world field of view of the image capture device 402 can represent the portion of the real-world environment that is capable of being viewed and/or captured by the image capture device 402. In some embodiments, the image capture device 402 can capture one or more real-world images, also referred to as video, of one or more tracking markers being displayed by the real-world user device as described herein. In some embodiments, the image capture device 402 can include one or more cameras. In the embodiments, the one or more cameras can include one or more external tracking cameras that are situated in the real-world environment, one or more pass-through cameras, one or more depth cameras, one or more red-green-blue (RGB) cameras that capture images of the real-world environment, one or more infrared cameras, and/or one or more eye tracking cameras, among others.

The controller 404 controls overall configuration and/or operation of the virtual reality display device 400. In some embodiments, the controller 404 can access the one or more real-world images captured by the image capture device 402. In these embodiments, the controller 404 can receive the one or more real-world images captured by the image capture device 402 over the display system bus 410. In some embodiments, the controller 404 can format these images for transmission to a virtual reality server, such as the virtual reality server 106 to provide an example. In these embodiments, the controller 404 can format the one or more real-world images into one or more image file formats, such as Joint Photographic Experts Group (JPEG) image file format, Exchangeable Image File Format (EXIF), Tagged Image File Format (TIFF), Graphics Interchange Format (GIF), bitmap image file (BMP) format, and/or Portable Network Graphics (PNG) image file format, among others to provide some examples. In these embodiments, the controller 404 can format the one or more real-world images in accordance with one or more communication standards or protocols for transmission to the virtual reality server. In these embodiments, the one or more communication standards or protocols can include one or more wireline communication standards or protocols, such as a version of an Institute of Electrical and Electronics Engineers (IEEE) 802.3 communication standard, also referred as Ethernet, such as 50G Ethernet, 100G Ethernet, 200G Ethernet, and/or 400G Ethernet, a version of Transmission Control Protocol/Internet Protocol (TCP/IP), a version of a Data Over Cable Service Interface Specification (DOCSIS) communication standard, such as DOCSIS 3.0, DOCSIS 3.1, and/or DOCSIS 3.1 Full Duplex to provide some examples, 3G, 4G, 4G long term evolution (LTE), and/or 5G to provide some examples, a version of an Institute of Electrical and Electronics Engineers (I.E.E.E.) 802.11 communication standard, for example, 802.11a, 802.11b/g/n, 802.11h, and/or 802.11ac which are collectively referred to as Wi-Fi, an I.E.E.E. 802.16 communication standard, also referred to as WiMax, and/or a version of a Bluetooth communication standard, among others. In some embodiments, the controller 404 can encode the one or more real-world images in accordance with one or more network protocols. In these embodiments, the one or more network protocols can include Hypertext Transfer Protocol (HTTP) Live Streaming (ILS), Dynamic Adaptive Streaming over HTTP (MPEG-DASH), WebRTC, Secure Reliable Transport (SRT), Real Time Messaging Protocol (RTMP), Real-time Transport Protocol (RTP), Real Time Streaming Protocol (RTSP), Transmission Control Protocol (TCP), User Datagram Protocol (LUDP), and/or Session Initiation Protocol (SIP), among others.

The communication module 406 represents a physical layer (PHY) interface between the virtual reality display device 400 and the virtual reality server. In some embodiments, the communication module 406 can access the one or more real-world images captured by the image capture device 402. In these embodiments, the communication module 406 can receive the one or more real-world images from the controller 404 over the display system bus 410. In some embodiments, the communication module 406 can transmit the one or more real-world images to the virtual reality server and/or receive a virtual user device, such as the virtual user device 110 to provide an example, the has been generated by the virtual reality server as described herein. In some embodiments, the communication module 406 can transmit the one or more real-world images and/or receive the virtual user device over a wired connection, or tethered connection, between the virtual reality display device 400 and the virtual reality server. In these embodiments, the wired connection can include a Universal Serial Bus (USB) wired connection and/or a High-Definition Multimedia Interface (HDMI) wired connection, among others. Alternatively, or in addition to, the communication module 406 can transmit the one or more real-world images and/or receive the virtual user device over a wireless connection, or untethered connection, between the virtual reality display device 400 and the virtual reality server. In these embodiments, the wireless connection, can include a Wi-Fi wireless connection, a cellular wireless connection, and a Bluetooth wireless connection, among others. In some embodiments, the communication module 406 can stream the one or more real-world images over the wireless connection in real-time, or near real-time.

The controller 404 can access the virtual user device that has been received by the communication module 406 for display on the display device 408 the virtual environment. In these embodiments, the controller 404 can receive the virtual user device from the communication module 406 over the display system bus 410. In some embodiments, the controller 404 can render the virtual user device onto one or more virtual surfaces in the virtual environment. In these embodiments, the control 404 can execute one or more graphical image rendering algorithms to render the virtual user device for display in the virtual environment. In some embodiments, the one or more graphical image rendering algorithms can include one or more scanline rendering and rasterization algorithms, one or more ray casting algorithms, one or more ray tracing algorithms, one or more neural rendering algorithms, and/or any other suitable graphical image rendering algorithms that will be apparent to those skilled in the relevant art(s) without departing from the spirit and scope of the present disclosure. As to be described in further detail below, the one or more graphical image rendering algorithms, when executed by the control 404, can manipulate one or more parameters, characteristics, and/or attributes, for example, orientations, scales, lighting, and/or angles, of the virtual user device to render the virtual user device for display in the virtual environment. In some embodiments, the one or more graphical image rendering algorithms, when executed by the control 404, can introduce one or more graphical image effects, such as shading, texture-mapping, bump-mapping, fogging, shadowing, reflecting, transparency, refracting, diffracting, illuminating, depth of field, motion blur, and/or non-photorealistic rendering to provide some examples, into the virtual user device.

The display device 408 can access the virtual user device that has been rendered by the controller 404 for display. In some embodiments, the display device 408 can receive the virtual user device from the controller 404 over the display system bus 410.

### Exemplary Operational Control Flows for the Exemplary Real-World Environment

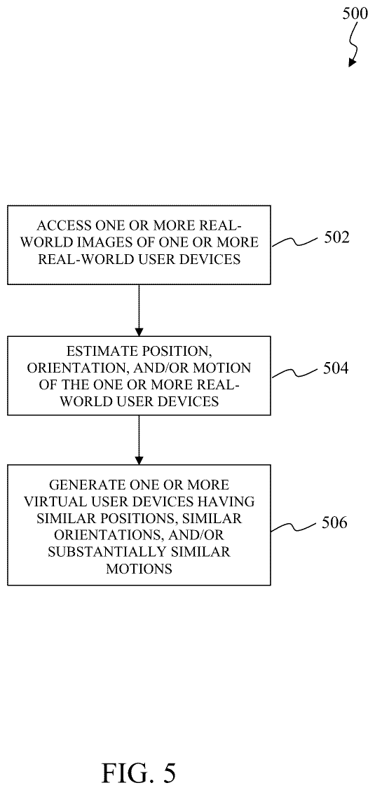

FIG. 5 illustrates an exemplary operational control flow for the exemplary real-world environment in accordance with some exemplary embodiments of the present disclosure. The following discussion is to describe an exemplary operational control flow 500. The present disclosure is not limited to these exemplary operational control flows. The exemplary operational control flow 500 can access one or more real-world images, also referred to as video, of one or more real-world user devices within a real-world environment, such as the real-world environment 100 to provide an example. The exemplary operational control flow 500 can transform the one or more real-world images of one or more real-world user devices into one or more virtual images of one or more virtual user devices. The exemplary operational control flow 500 can display the one or more virtual images of one or more virtual user devices in a virtual environment, such as the virtual environment 102 to provide an example, to provide immersive interactions between the one or more real-world user devices in the real-world environment and one or more virtual user devices in the virtual environment. In some embodiments, the operational control flow 500 can be performed by the virtual reality display device 104, the virtual reality server 105, and/or any combination thereof.

At operation 502, the operational control flow 500 can access the one or more real-world images, also referred to as video, of the one or more real-world user devices within the real-world environment. In some embodiments, the operational control flow 500 can capture, or acquire, the one or more real-world images, also referred to as video, of the one or more real-world user devices in the real-world environment as described herein. In these embodiments, the operational control flow 500 can capture one or more real-world images, also referred to as video, of one or more tracking markers being displayed by the one or more real-world user devices as described herein.

At operation 504, the operational control flow 500 can estimate position, orientation, for example, roll, pitch, and/or yaw, and/or motion of the one or more real-world devices in the real-world environment as described herein.

At operation 506, the operational control flow 500 can generate the one or more virtual user devices for display in the virtual environment having substantially similar positions, substantially similar orientations, for example, rolls, pitches, and/or yaws, and/or substantially similar motions as the one or more real-world devices in the real-world environment. In some embodiments, the operational control flow 500 can decode the one or more tracking markers extracted from the one or more real-world images of the one or more real-world devices as described herein to identify the one or more virtual user devices as described herein. In these embodiments, the operational control flow 500 can decode the one or more tracking markers to recover one or more identifiers and/or metadata, among others, that have been encoded within the one or more tracking markers as described herein. In these embodiments, the operational control flow 500 can access one or more images, or video, to be displayed in the virtual environment as the one or more virtual user devices that are associated with the one or more identifiers as described herein. In some embodiments, the operational control flow 500 can render the one or more images, or video, to have the substantially similar position, the substantially similar orientation, and/or the substantially similar motion as the one or more real-world devices in the real-world environment to generate the one or more virtual user devices as described herein.

Exemplary Computer System that can be Implemented within the Exemplary Real-World Environment

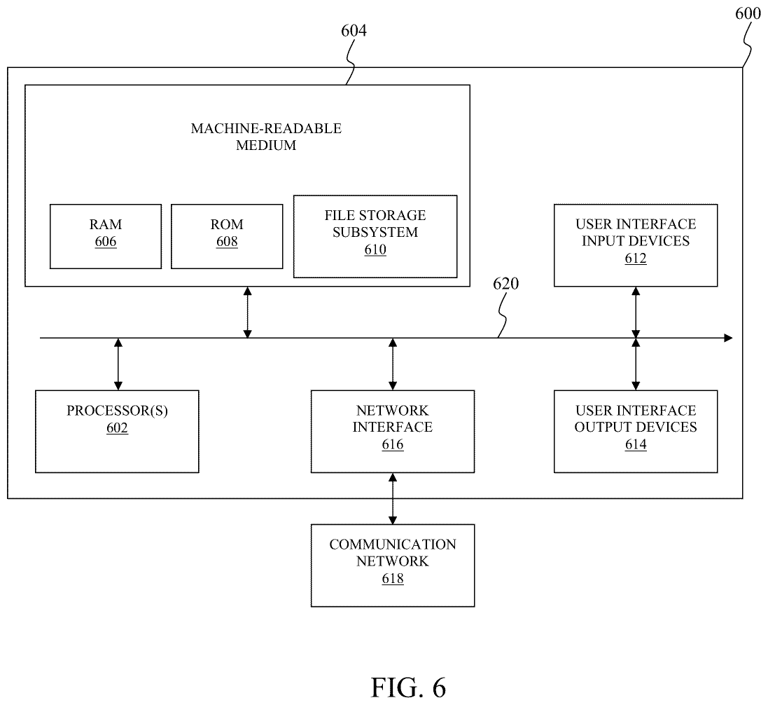

FIG. 6 illustrates a simplified block diagram of an exemplary computer system that can be implemented within the exemplary real-world environment according to some exemplary embodiments of the present disclosure. The discussion of FIG. 6 to follow is to describe a computer system 600 that can be used to implement the virtual reality display device 104 and/or the virtual reality server 106, among others, as described herein.

In the exemplary embodiment illustrated in FIG. 6, the computer system 600 includes one or more processors 602. In some embodiments, the one or more processors 602 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical, or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors, or combinations of these elements. The processor can be electronic, for example, comprising digital logic circuitry (for example, binary logic), or analog (for example, an operational amplifier). The processor may also operate to support performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computer system 600 can include an operating system, such as Microsoft's Windows, Sun Microsystems's Solaris, Apple Computer's MacOs, Linux or UNIX. In some embodiments, the computer system 600 can also include a Basic Input/Output System (BIOS) and processor firmware. The operating system, BIOS and firmware are used by the one or more processors 602 to control subsystems and interfaces coupled to the one or more processors 602. In some embodiments, the one or more processors 602 can include the Pentium and Itanium from Intel, the Opteron and Athlon from Advanced Micro Devices, and the ARM processor from ARM Holdings.

As illustrated in FIG. 6, the computer system 600 can include a machine-readable medium 604. In some embodiments, the machine-readable medium 604 can further include a main random-access memory (“RAM”) 606, a read only memory (“ROM”) 608, and/or a file storage subsystem 610. The RAM 606 can store instructions and data during program execution and the ROM 608 can store fixed instructions. The file storage subsystem 610 provides persistent storage for program and data files, and may include a hard disk drive, a floppy disk drive along with associated removable media, a CD-ROM drive, an optical drive, a flash memory, or a removable media cartridge.

The computer system 600 can further include user interface input devices 612 and user interface output devices 614. The user interface input devices 612 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 612 can be connected by wire or wirelessly to the computer system 600. Generally, the user interface input devices 612 are intended to include all possible types of devices and ways to input information into the computer system 600. The user interface input devices 612 typically allow a user to identify objects, icons, text, and the like that appear on some types of user interface output devices, for example, a display subsystem. The user interface output devices 614 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 614 are intended to include all possible types of devices and ways to output information from the computer system 600.

The computer system 600 can further include a network interface 616 to provide an interface to outside networks, including an interface to a communication network 618, and is coupled via the communication network 618 to corresponding interface devices in other computer systems or machines. The communication network 618 may comprise many interconnected computer systems, machines, and communication links. These communication links may be wired links, optical links, wireless links, or any other devices for communication of information. The communication network 618 can be any suitable computer network, for example a wide area network such as the Internet, and/or a local area network such as Ethernet. The communication network 618 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 6, the one or more processors 602, the machine-readable medium 604, the user interface input devices 612, the user interface output devices 614, and/or the network interface 616 can be communicatively coupled to one another using a bus subsystem 620. Although the bus subsystem 620 is shown schematically as a single bus, alternative embodiments of the bus subsystem may use multiple buses. For example, RAM-based main memory can communicate directly with file storage systems using Direct Memory Access (“DMA”) systems.

### CONCLUSION

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A virtual reality server for generating a virtual user device in a virtual environment that is associated with a real-world user device in a real-world environment, the virtual reality server comprising:
a memory configured to store one or more real-world images of the real-world user device in the real-world environment; and
a processor configured to execute instructions stored in the memory, the instructions, when executed by the processor, configuring the processor to:
extract one or more tracking markers from the one or more real-world images of the real-world user device,
estimate a pose of the real-world user device from the one or more tracking markers,
decode the one or more tracking markers to identify one or more virtual images that are associated with the virtual user device, and
render the one or more virtual images to have the pose of the real-world user device to generate the virtual user device for display in the virtual environment.

2. The virtual reality server of claim 1, wherein the instructions, when executed by the processor, configure the processor to receive the one or more real-world images of the real-world user device from a virtual reality display device that is to display the virtual user device in the virtual environment.

3. The virtual reality server of claim 2, wherein the instructions, when executed by the processor, configure the processor to receive the one or more real-world images of the real-world user device from the virtual reality display device in real-time.

4. The virtual reality server of claim 1, wherein the pose of the real-world user device comprises a position, an orientation, or a motion of the real-world user device in the real-world environment, and
wherein the instructions, when executed by the processor, configure the processor to estimate the positon, the orientation, or the motion of the real-world user device from the one or more tracking markers.

5. The virtual reality server of claim 1, wherein the instructions, when executed by the processor, configure the processor to estimate the pose of the real-world user device in relative to a virtual reality display device that is to display the virtual user device in the virtual environment.

6. The virtual reality server of claim 1, wherein the instructions, when executed by the processor, configure the processor to:
decode the one or more tracking markers to recover one or more identifiers that have been encoded within the one or more tracking markers; and
access the one or more virtual images that are associated with the one or more identifiers.

7. The virtual reality server of claim 1, wherein the one or more tracking markers comprise one or more ArUco markers.

8. A method for generating a virtual user device in a virtual environment that is associated with a real-world user device in a real-world environment, the method comprising:
accessing, by a virtual reality server, one or more real-world images of the real-world user device in the real-world environment;
extracting, by the virtual reality server, one or more tracking markers from the one or more real-world images of the real-world user device;
estimating, by the virtual reality server, a pose of the real-world user device from the one or more tracking markers;
decoding, by the virtual reality server, the one or more tracking markers to identify one or more virtual images that are associated with the virtual user device; and
rendering, by the virtual reality server, the one or more virtual images to have the pose of the real-world user device to generate the virtual user device for display in the virtual environment.

9. The method of claim 8, wherein the accessing comprises receiving the one or more real-world images of the real-world user device from a virtual reality display device that is to display the virtual user device in the virtual environment.

10. The method of claim 9, wherein the accessing comprises receiving the one or more real-world images of the real-world user device from the virtual reality display device in real-time.

11. The method of claim 8, wherein the pose of the real-world user device comprises a position, an orientation, or a motion of the real-world user device in the real-world environment, and
wherein the estimating comprises estimating the positon, the orientation, or the motion of the real-world user device from the one or more tracking markers.

12. The method of claim 8, wherein the estimating comprises estimating the pose of the real-world user device in relative to a virtual reality display device that is to display the virtual user device in the virtual environment.

13. The method of claim 8, wherein the decoding comprises:
decoding the one or more tracking markers to recover one or more identifiers that have been encoded within the one or more tracking markers; and
accessing the one or more virtual images that are associated with the one or more identifiers.

14. The method of claim 8, wherein the one or more tracking markers comprise one or more ArUco markers.

15. A system for generating a virtual user device in a virtual environment that is associated with a real-world user device in a real-world environment, the system comprising:
a virtual reality display device configured to capture one or more real-world images of the real-world user device in the real-world environment; and
a virtual reality server configured to:
extract one or more tracking markers from the one or more real-world images of the real-world user device,
estimate a pose of the real-world user device from the one or more tracking markers,
decode the one or more tracking markers to identify one or more virtual images that are associated with the virtual user device, and
render the one or more virtual images to have the pose of the real-world user device to generate the virtual user device for display in the virtual environment.

16. The system of claim 15, wherein the virtual reality server is configured to receive the one or more real-world images of the real-world user device from a virtual reality display device that is to display the virtual user device in the virtual environment.

17. The system of claim 16, wherein the virtual reality server is configured to receive the one or more real-world images of the real-world user device from the virtual reality display device in real-time.

18. The system of claim 15, wherein the pose of the real-world user device comprises a position, an orientation, or a motion of the real-world user device in the real-world environment, and
wherein the virtual reality server is configured to estimate the positon, the orientation, or the motion of the real-world user device from the one or more tracking markers.

19. The system of claim 15, wherein the virtual reality server is configured to estimate the pose of the real-world user device in relative to a virtual reality display device that is to display the virtual user device in the virtual environment.

20. The system of claim 15, wherein the virtual reality server is configured to:
decode the one or more tracking markers to recover one or more identifiers that have been encoded within the one or more tracking markers; and
access the one or more virtual images that are associated with the one or more identifiers.
